(19) United States
(12) Patent Application Publication
(10) Pub. No.: US 2016/0153546 A1
(43) Pub. Date: Jun. 2, 2016

(54) LUBRICATING STRUCTURE FOR SPEED REDUCER

(71) Applicants: Aisin Seiki Kabushiki Kaisha, Kariya-shi (JP); Aisin Aw Co., Ltd., Anjo-shi (JP); TOYOTA JIDOSHA KABUSHIKI KAISHA, Toyota-shi (JP)

(72) Inventors: Kazumi OGAWA, Toyota-shi (JP); Atsushi KAJIKAWA, Hekinan-shi (JP); Tsuyoshi MIYAJI, Anjo-shi (JP); Yuya TAKEUCHI, Anjo-shi (JP); Masaya MICHISHITA, Okazaki-shi (JP); Yoshihiro IKUSHIMA, Okazaki-shi (JP)

(73) Assignees: Aisin Seiki Kabushiki Kaisha, Kariya-shi (JP); Aisin Aw Co., Ltd., Anjo-shi (JP); TOYOTA JIDOSHA KABUSHIKI KAISHA, Toyota-shi (JP)

(21) Appl. No.: 14/948,570

(22) Filed: Nov. 23, 2015

(30) Foreign Application Priority Data
Nov. 27, 2014 (JP) 2014-239593

(51) Int. Cl. F16H 57/04; F16H 1/22

(52) U.S. Cl. CPC F16H 57/0476; F16H 57/0457; F16H 1/22

(57) ABSTRACT

A lubricating structure for a speed reducer includes: a case; an electric motor arranged inside the case; a reduction gear configured to rotate interlocking with an output shaft of the electric motor; a pair of drive axles configured to be driven to rotate by torque transmitted from the electric motor via the reduction gear; and a catch tank configured to store part of oil by scooping up the oil with the use of the reduction gear. The reduction gear is located on a front side of the vehicle with respect to a rotor of the electric motor, and is arranged such that a lower-side common tangent of an outer peripheral circle of the reduction gear and an outer peripheral circle of the rotor is inclined upward from the front side of the vehicle toward a rear side of the vehicle at a predetermined angle with respect to a horizontal line.

### INCORPORATION BY REFERENCE

The disclosure of Japanese Patent Application No. 2014-239593 filed on Nov. 27, 2014 including the specification, drawings and abstract is incorporated herein by reference in its entirety.

### BACKGROUND OF THE INVENTION

1. Field of the Invention

The invention relates to a lubricating structure for a speed reducer and, more particularly, to a lubricating structure for a speed reducer, which reduces the stirring resistance of a reduction gear during traveling of a vehicle by driving a pair of drive axles to rotate by using torque transmitted from an electric motor via the reduction gear, scooping up oil, which is stored at a bottom in a case and supplied to a lubricated portion and a heat-generating portion, with the use of the reduction gear and storing part of the scooped-up oil in a catch tank.

2. Description of Related Art

There is known a structure that a motor shaft of an electric motor is arranged upward on a vehicle rear side with respect to a reduction gear (counter driven gear) that scoops up oil (see, for example, Japanese Patent Application Publication No. 2005-201316 (JP 2005-201316 A)).

### SUMMARY OF THE INVENTION

However, as described above, with the structure that the motor shaft is arranged upward with respect to the reduction gear that scoops up oil, oil stored at the lower side of the case is scooped up by the reduction gear, and the level of the oil lowers, so a rotor of the electric motor is not immersed in oil in advance of immersion of the reduction gear. As a result, it is not possible to splash oil by the use of rotation of the rotor although the rotor is rotating, so it has not been possible to cool the rotor and stator coil unit that are heat-generating portions of the electric motor by the splashes of oil.

The invention provides a lubricating structure for a speed reducer, which is able to splash oil by the use of rotation of a rotor of an electric motor and is able to cool a heat-generating portion of the electric motor in a state where the rotor is rotating.

An aspect of the invention provides a lubricating structure for a speed reducer. The lubricating structure includes: a case for a drive system of a vehicle; an electric motor arranged inside the case; a reduction gear configured to rotate interlocking with an output shaft of the electric motor; a pair of drive axles configured to be driven to rotate by torque transmitted from the electric motor via the reduction gear; and a catch tank configured to store part of oil, which is stored at a bottom in the case and supplied to a lubricated portion and a heat-generating portion of the electric motor, by scooping up the oil with the use of the reduction gear. The reduction gear is located on a front side of the vehicle with respect to a rotor of the electric motor, and is arranged such that a lower-side common tangent of an outer peripheral circle of the reduction gear and an outer peripheral circle of the rotor is inclined upward from the front side of the vehicle toward a rear side of the vehicle at a predetermined angle with respect to a horizontal line.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeletal view that illustrates the schematic configuration of a rear transaxle of a vehicle to which the invention is applied;

FIG. 2 is a front view that shows an opening side of a first split case portion of a transaxle case according to an embodiment of the invention, the opening side being a side to be mated with an opening side of a second split case portion;

FIG. 3 is a partially perspective view of FIG. 2;

FIG. 4 is a front view that shows the opening side of the second split case portion of the transaxle case according to the embodiment of the invention, the opening side being a side to be mated with the opening side of the first split case portion;

FIG. 5 is a partially perspective view of FIG. 4;

FIG. 6 is a front view that shows an opening side of the first split case portion of the transaxle case according to the embodiment of the invention, the opening side being a side to be mated with an opening side of a third split case portion;

FIG. 7 is a view that shows an operating state on a flat road in a lubricating structure for a speed reducer according to the embodiment of the invention; and

FIG. 8 is a view that shows an operating state on an uphill in the lubricating structure for a speed reducer according to the embodiment of the invention.

### DETAILED DESCRIPTION OF EMBODIMENTS

An embodiment of the invention will be described in detail with reference to the accompanying drawings. Like reference numerals denote the same or corresponding members in the drawings referenced below.

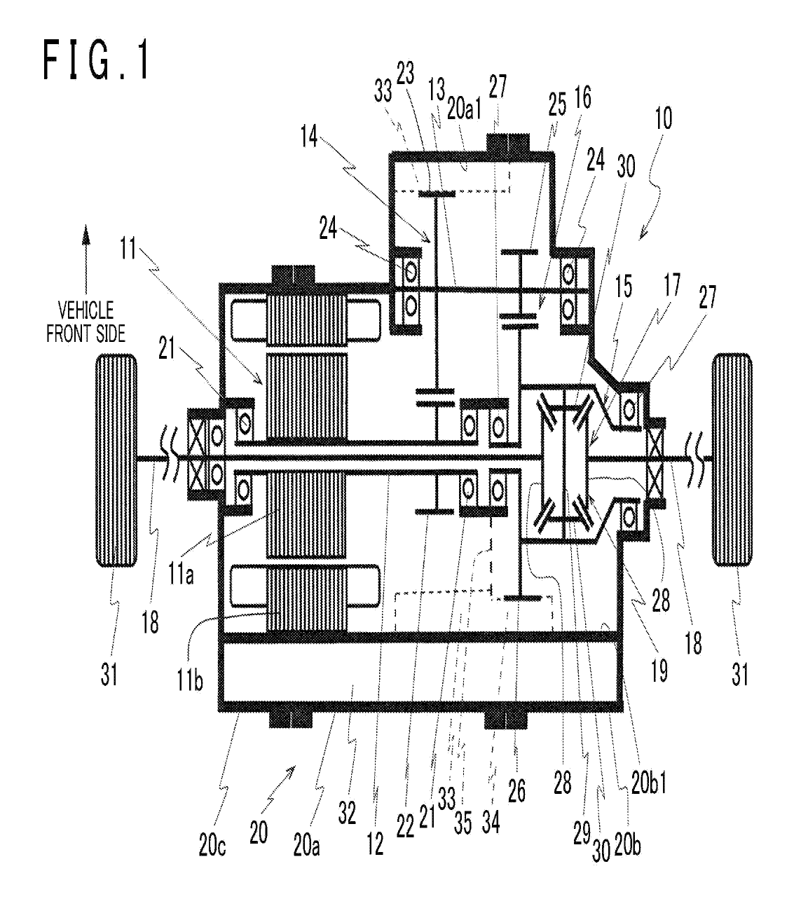

FIG. 1 is a skeletal view that shows the configuration of a rear transaxle 10 of an electric four-wheel-drive vehicle, which is a drive system of a vehicle and to which a lubricating structure for a speed reducer according to the invention is applied. The rear transaxle 10 is a dual-axis electric drive system of a vehicle. The rear transaxle 10 includes an electric motor 11 as a drive source, a first reduction gear pair 14, a second reduction gear pair 16 and a differential gear unit 19 inside a transaxle case 20 (which is an example of a case). The first reduction gear pair 14 is provided between an output shaft 12 of the electric motor 11 and a counter shaft 13 parallel to the output shaft 12. The second reduction gear pair 16 is provided between the counter shaft 13 and a differential case 15 parallel to the counter shaft 13 and concentric with the electric motor 11. The differential gear unit 19 includes the differential mechanism 17 provided inside the differential case 15. The differential gear unit 19 drives a pair of rear axles 18 (which are an example of drive axles) to rotate by the use of torque transmitted from the electric motor 11 via the first reduction gear pair 14 and the second reduction gear pair 16.

A rotor 11a of the electric motor 11 is coupled to the center portion of the output shaft 12. A pair of bearings 21 are fitted to both ends of the output shaft 12. Thus, the output shaft 12 is rotatably supported by the transaxle case 20 via the pair of bearings 21. A stator coil unit 11b is provided around the rotor 11a, and is fixed to the transaxle case 20.

The first reduction gear pair 14 consists of a small-diameter counter drive gear 22 and a large-diameter counter driven gear 23 (which is an example of a reduction gear). The counter drive gear 22 is integrally fixed to the distal end side of one end of the output shaft 12. The counter driven gear 23 is integrally fixed to one end side of the counter shaft 13 in a state where the counter driven gear 23 is in mesh with the counter drive gear 22.

Because a fuel tank (not shown) is arranged on the vehicle front side of the rear axles 18, a predetermined shock-absorbing zone is provided on the vehicle rear side of the rear axles 18. No component having a high stiffness is arranged in the predetermined shock-absorbing zone. The counter shaft 13 is provided on the vehicle front side with respect to the concentric output shaft 12, differential case 15 and rear axles 18, the rotor 11a and counter drive gear 22 fixed to the output shaft 12, and a final driven gear 26 (described later) fixed to the differential case 15. Thus, the counter driven gear 23 is arranged at the frontmost side inside the transaxle case 20. A pair of bearings 24 are respectively fitted to both ends of the counter shaft 13. The counter shaft 13 is rotatably supported by the transaxle case 20 via these pair of bearings 24.

As shown in FIG. 1, the second reduction gear pair 16 is arranged so as to be displaced in the rotation axis direction of the first reduction gear pair 14. The second reduction gear pair 16 consists of a small-diameter final drive gear 25 and the large-diameter final driven gear 26. The final drive gear 25 is integrally fixed to the other end of the counter shaft 13. The final driven gear 26 is arranged so as to be displaced from the counter drive gear 22 in the axial direction of the output shaft 12. The final driven gear 26 is fitted to the outer peripheral portion of the differential case 15 and integrally fixed in a state where the final driven gear 26 is in mesh with the final drive gear 25.

A pair of bearings 27 are respectively fitted to the outer peripheries of both axial ends of the differential case 15. Therefore, the final driven gear 26 integrally fixed to the differential case 15 and the differential case 15 are rotatably supported by the transaxle case 20 via these pair of bearings 27.

The differential mechanism 17 is of a generally known so-called bevel gear type. The differential mechanism 17 includes a pair of side gears 28 and a pair of pinion gears 30. The pair of side gears 28 are opposed to each other along the rotation axis inside the differential case 15. The pair of pinion gears 30 are rotatably supported by a pinion shaft 29 between these pair of side gears 28, and each are in mesh with the pair of side gears 28. The pinion shaft 29 is fixed to the differential case 15 in a state where the pinion shaft 29 is perpendicular to the rotation axis of the differential case 15.

The pair of rear axles 18 are respectively integrally coupled to the pair of side gears 28. The differential gear unit 19 that includes the differential case 15 and the differential mechanism 17 drives the pair of rear axles 18 to rotate by the use of torque transmitted from the electric motor 11 via the first reduction gear pair 14 and the second reduction gear pair 16 while allowing a rotation speed difference between the pair of rear axles 18. One of the pair of rear axles 18 is inserted through the hollow cylindrical output shaft 12 and is coupled to a vehicle left-side one of a pair of rear wheels 31. That is, the output shaft 12 and the pair of rear axles 18 are arranged coaxially with each other for space-saving arrangement.

The transaxle case 20 is split into three portions in the axis direction of the rear axles 18 and is formed of a plurality of split case portions. That is, the transaxle case 20 is formed in an oil-tight manner by fastening a cylindrical first split case portion 20a, a lid-shaped second split case portion 20b and a lid-shaped third split case portion 20c to each other by bolts (not shown). The first split case portion 20a mainly accommodates the first reduction gear pair 14. The second split case portion 20b mainly accommodates the second reduction gear pair 16. The third split case portion 20c mainly accommodates the electric motor 11. The transaxle case 20 according to the present embodiment is of a three-portion split type in which the first split case portion 20a is located near the center in the width direction of the vehicle, the second split case portion 20b is coupled to the vehicle right side of the first split case portion 20a and the third split case portion 20c is coupled to the vehicle left side of the first split case portion 20a, that is, the third split case portion 20c is coupled to the side of the first split case portion 20a across from the second split case portion 20b. These split case portions are made of a cast light alloy, for example, by aluminum die-casting, or the like.

The counter driven gear 23 and the final driven gear 26 are configured to rotate to supply oil to lubricated portions by scooping up oil stored at the bottom in the transaxle case 20. That is, scoop-up lubrication is employed in the rear transaxle 10 according to the present embodiment. The scoop-up lubrication is to supply oil to the lubricated portions by scooping up oil that is stored at the bottom inside the transaxle case 20. The lubricated portions are, for example, meshing portions of the first reduction gear pair 14 and second reduction gear pair 16, gear meshing portions and rotational sliding portions of the differential mechanism 17, the bearings 21, 24, 27, and the like.

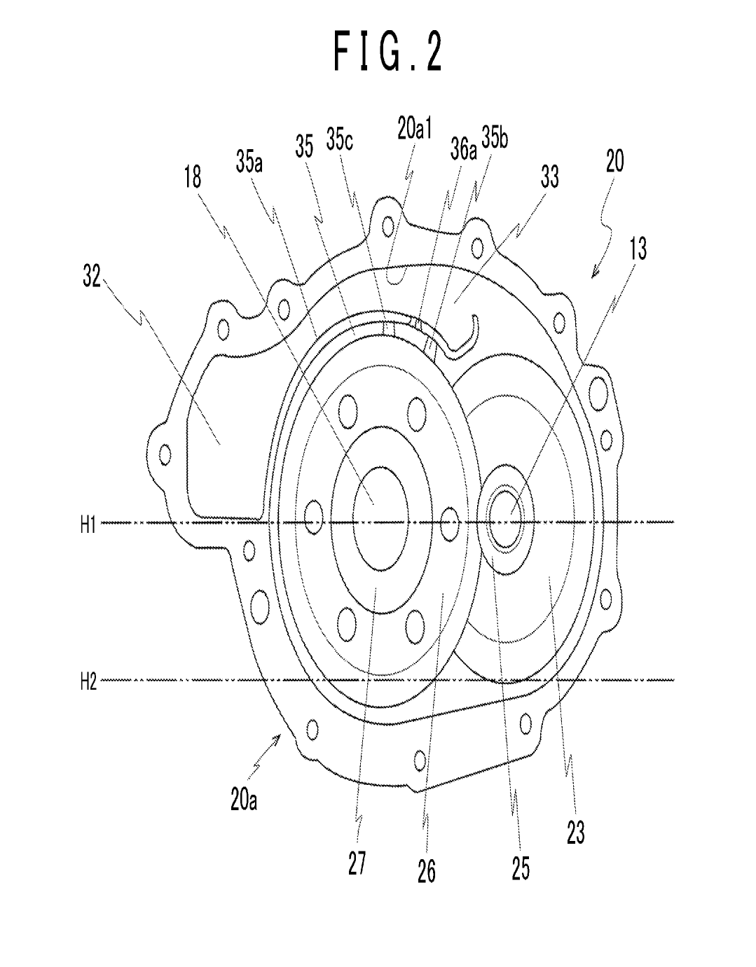

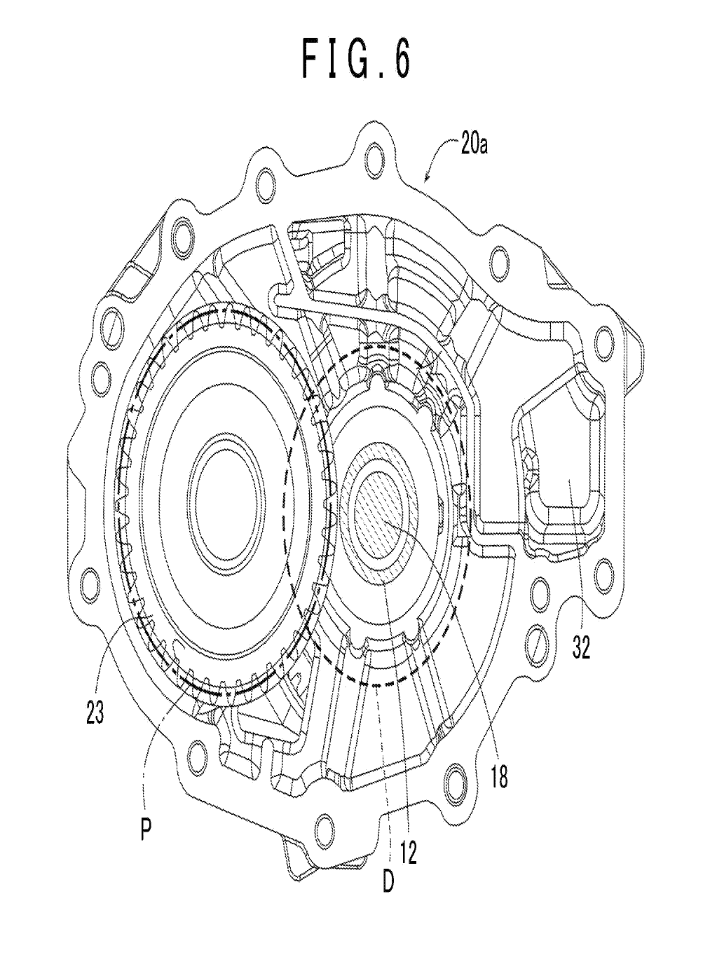

The transaxle case 20 includes a catch tank 32 for storing part of scooped-up oil in order to lower the oil level position of oil that is stored at the bottom inside the transaxle case 20 for the purpose of reducing the stirring resistance of oil against the counter driven gear 23, which increases with an increase in vehicle speed V. As shown in FIG. 2 to FIG. 6, the catch tank 32 is provided over the split case portions 20a, 20b, 20c such that oil is stored at a position higher than the oil level position at the bottom in the transaxle case 20.

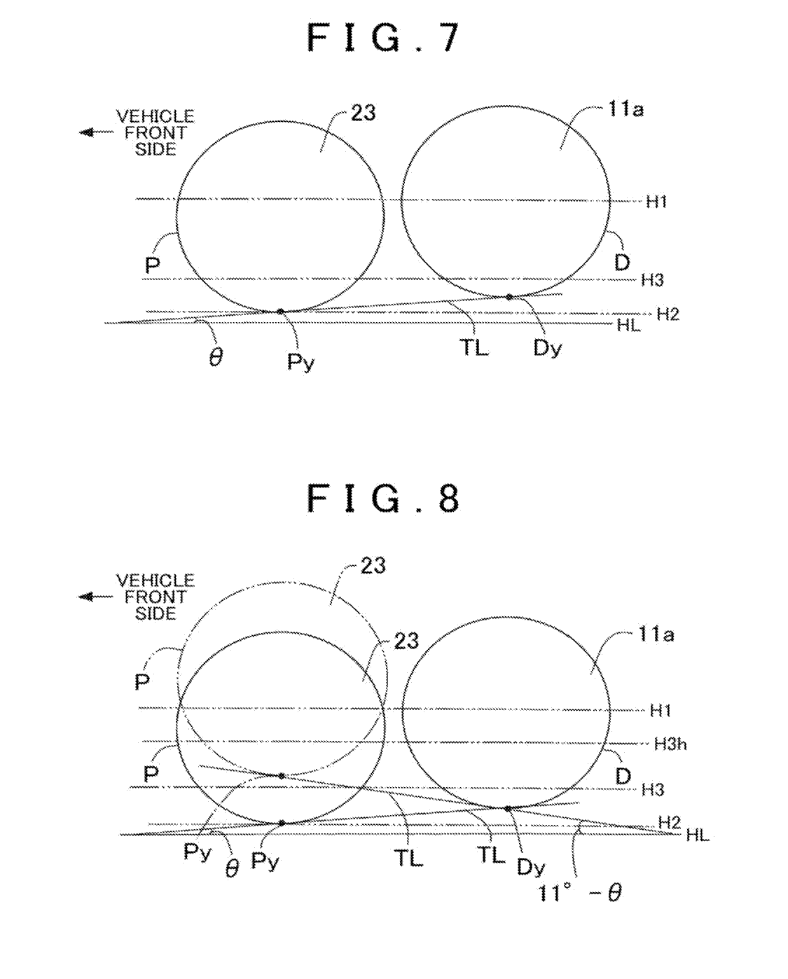

As shown in FIG. 7, the counter driven gear 23 is arranged on the vehicle front side with respect to the rotor 11a of the electric motor 11, and is arranged such that a lower-side common tangent TL of an outer peripheral circle P of the counter driven gear 23 and an outer peripheral circle D of the rotor 11a is inclined upward from the front side of the vehicle to the rear side of the vehicle at a predetermined angle θ with respect to a horizontal line HL. Py indicates the lowermost end of the outer peripheral circle P of the counter driven gear 23, and Dy indicates the lowermost end of the outer peripheral circle D of the rotor 11a.

Generally, because front wheels (not shown) that are drive wheels begin to slip when the vehicle travels on an uphill that is a low μ road (a road having a low friction coefficient), such as a snow road, in a front-wheel-drive two-wheel-drive mode, the vehicle changes the drive mode to a four-wheel-drive mode by driving the rear wheels 31 with the use of the electric motor 11, which is an auxiliary power source for generating auxiliary driving force, and begins to travel. The predetermined angle θ is, for example, an angle corresponding to the angle of such an uphill in this case. Thus, while the vehicle starts moving and traveling on an uphill by operating the electric motor 11, the lowermost end Py of the outer peripheral circle P of the reduction gear 23 is located above the lowermost end Dy of the outer peripheral circle D of the rotor 11a because of the predetermined angle θ. As a result, even in a state where the reduction gear 23 is not immersed in oil stored at the bottom in the case 20, the rotor 11a is kept immersed in oil stored at the bottom in the case 20, so it is possible to cool the heat-generating portions of the electric motor 11, that is, the rotor 11a and the stator coil unit 11b, by the use of the splashes of oil resulting from rotation of the rotor 11a.

The predetermined angle θ is set such that the lowermost end Dy of the outer peripheral circle D of the rotor 11a is not immersed in oil stored in the case 20 while the vehicle is traveling on a hill having a gradient that falls within a predetermined angular range, in which the vehicle does not require auxiliary driving force that is generated by the electric motor 11. Thus, while the vehicle is traveling, it is possible not to immerse the rotor 11a in oil stored in the case 20 when the electric motor 11 is not in operation, so it is possible to reduce the stirring resistance of the reduction gear 23 due to immersion of the rotor 11a in oil during traveling of the vehicle. A specific example of the predetermined angle θ that satisfies both of the above conditions is substantially 5°. Generally, in the four-wheel-drive mode using the electric motor 11, the vehicle is able to climb an uphill having an angle of 11°.

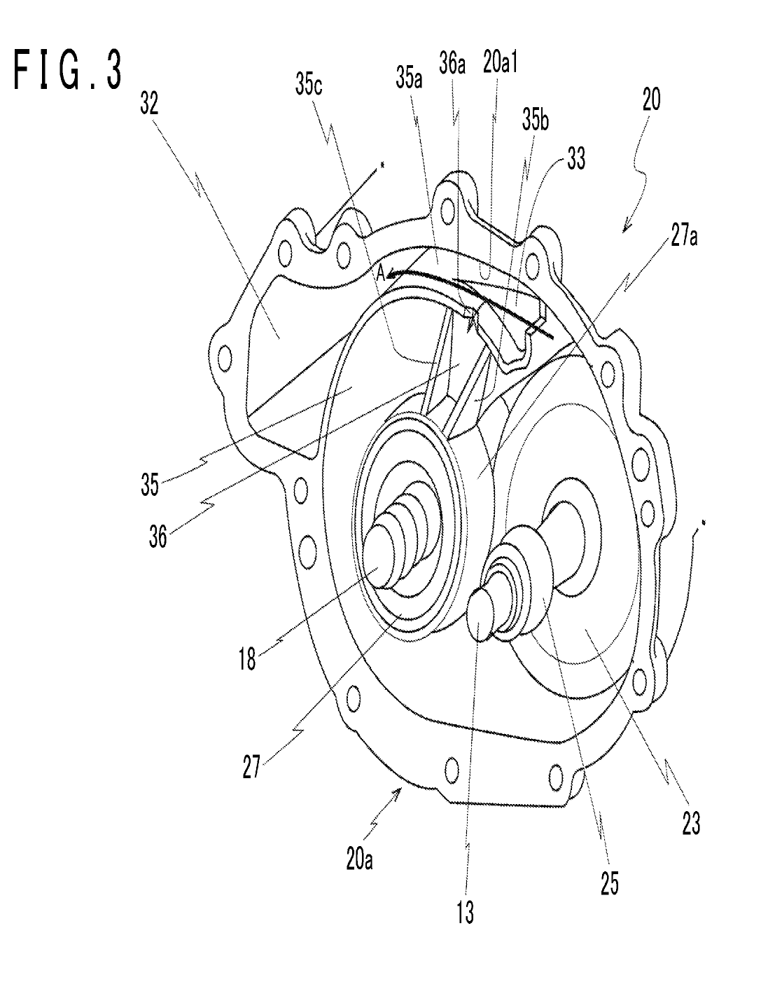

Because most of oil that is scooped up by the counter driven gear 23 of the first reduction gear pair 14 is splashed upward and rearward as indicated by the arrow A in FIG. 3, the catch tank 32 is arranged at a position at which the catch tank 32 is able to efficiently contain scooped-up oil, that is, at the rearmost side of the transaxle case 20.

Thus, the oil scoop-up operation of the counter driven gear 23 that is higher in rotation speed and higher in ability to scoop up oil (that has a larger scoop-up amount) than the final driven gear 26 of the second reduction gear pair 16 is smoothly carried out. Oil stored in the catch tank 32 is supplied from an oil supply port (not shown) provided in the catch tank 32 to another lubricated portion, overflows from the catch tank 32 as a result of accumulation of oil at or above a predetermined amount or is supplied as naturally drained oil from a drain port (not shown), provided at the bottom of the catch tank 32, to lubrication required portions, such as bearings and oil seals that are not immersed in oil as a result of a decrease in the oil level position at the bottom in the transaxle case 20. Thus, oil is returned to the bottom inside the transaxle case 20.

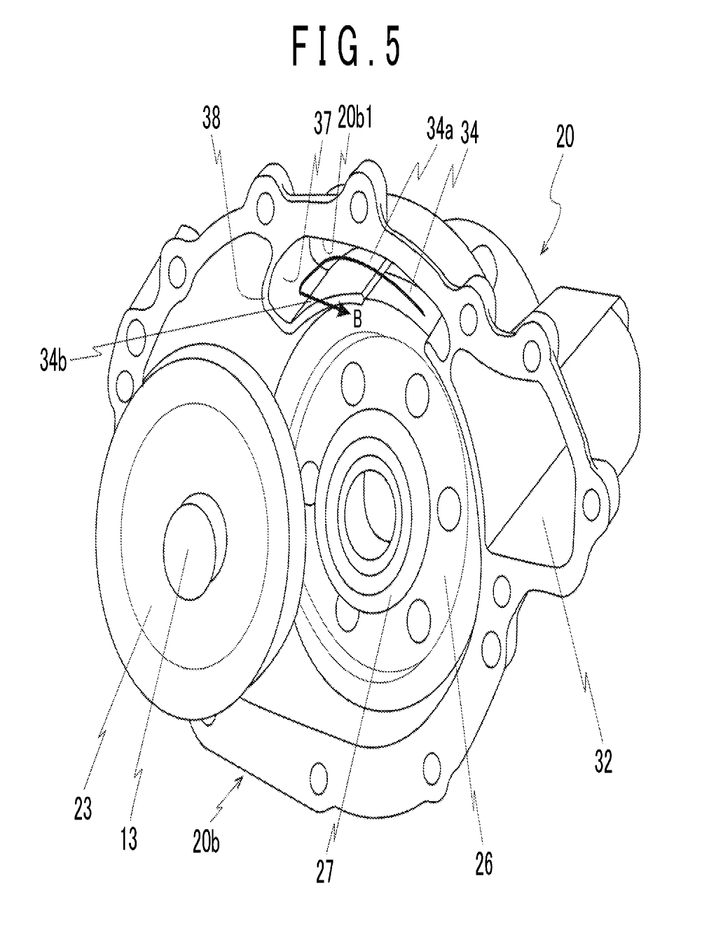

A first oil passage 33 is provided inside the first split case portion 20a of the transaxle case 20. The first oil passage 33 guides oil, which is scooped up by the counter driven gear 23 of the first reduction gear pair 14, to the catch tank 32 as indicated by the arrow A in FIG. 3. On the other hand, a second oil passage 34 is provided inside the second split case portion 20b of the transaxle case 20. The second oil passage 34 guides oil, which is scooped up by the final driven gear 26 of the second reduction gear pair 16, to the catch tank 32 as indicated by the arrow B in FIG. 5. As shown in FIG. 1, the second oil passage 34 is arranged so as to be displaced with respect to the first oil passage 33 in the axial direction of the counter shaft 13 (that is, rightward in FIG. 1) that is the rotary shaft of the counter driven gear 23 of the first reduction gear pair 14.

A wall portion 35 is provided inside the first split case portion 20a of the transaxle case 20. The wall portion 35 supports the bearing 27 for the final driven gear 26 as shown in FIG. 3. The first oil passage 33 is formed on an outer periphery 35a of the wall portion 35, that is, the first oil passage 33 is radially defined by the outer periphery 35a of the wall portion 35 and an outer peripheral wall 20a1 of the first split case portion 20a. The first oil passage 33 guides oil, which is scooped up by the counter driven gear 23, to the catch tank 32.

As shown in FIG. 2 and FIG. 3, the wall portion 35 has a supply passage 36 that communicates the first oil passage 33 with the lubricated portion of the bearing 27 to guide part of oil, flowing through the first oil passage 33, to the bearing 27. Specifically, the supply passage 36 communicates with the first oil passage 33 via a communication hole 36a extending through the outer periphery 35a of the wall portion 35, the inside of the wall portion 35 is defined by reinforcement ribs 35b, 35c that are provided on the wall portion 35 and that reinforce a bearing support portion 27a for the bearing 27, and the supply passage 36 is configured to lubricate by communicating the first oil passage 33 with the lubricated portion of the bearing 27.

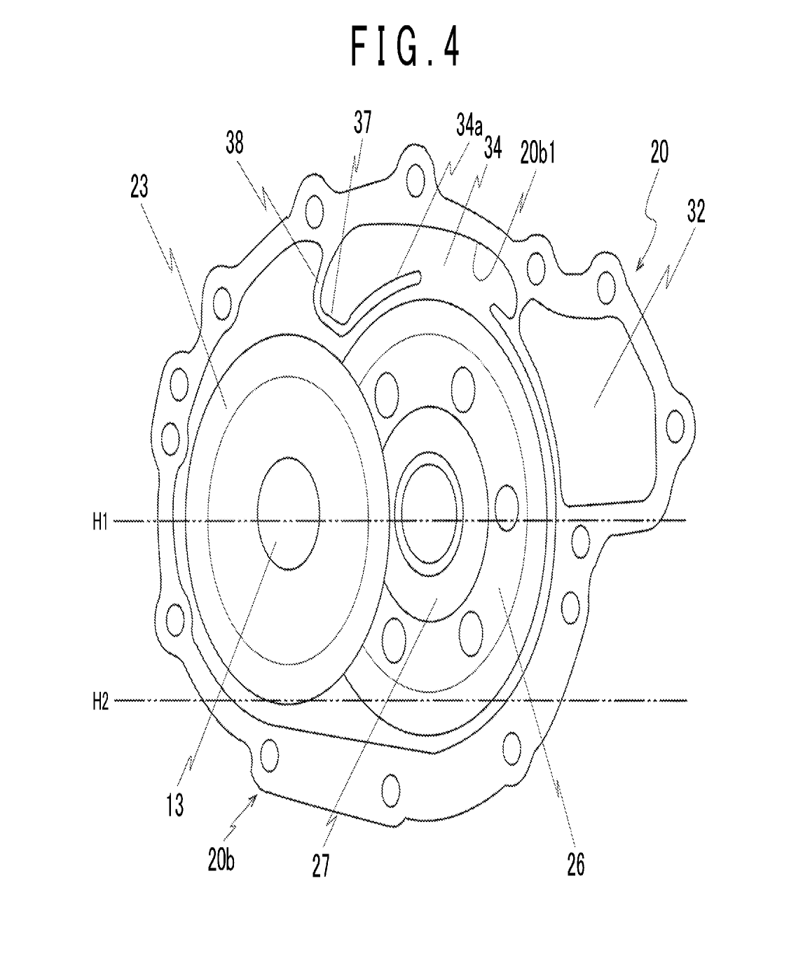

As shown in FIG. 4 and FIG. 5, inside the second split case portion 20b of the transaxle case 20, the second oil passage 34 includes a first guide passage 34a that guides oil to a receiving portion 37 that receives oil scooped up by the final driven gear 26 of the second reduction gear pair 16. The first guide passage 34a extends in a direction to face the first oil passage 33. The second oil passage 34 further includes a second guide passage 34b that guides oil, scooped up by the final driven gear 26, from the receiving portion 37 to the first oil passage 33.

As shown in FIG. 4 and FIG. 5, the first guide passage 34a is radially defined by an intermediate wall 38 and an outer peripheral wall 20b1 of the second split case portion 20b at the distal end side of the intermediate wall 38 extending from the outer peripheral wall 20b1 of the second split case portion 20b toward the radially inner side. The first guide passage 34a guides oil, which is scooped up by the final driven gear 26, to the receiving portion 37 located at the downstream side of the first guide passage 34a. The upstream side, which is the receiving portion 37 side, of the second guide passage 34b is defined on the intermediate wall 38, and the downstream side of the second guide passage 34b merges with the first oil passage 33.

As shown in FIG. 2 and FIG. 4, the counter driven gear 23 of the first reduction gear pair 14 and the final driven gear 26 of the second reduction gear pair 16 are arranged at the level at which at least substantially the lower half of each of the counter driven gear 23 and the final driven gear 26 is immersed in oil that is stored at the bottom in the transaxle case 20 in a state where the vehicle is stopped. The level H1 indicated by the alternate long and two-short dashes line in FIG. 2, FIG. 4, FIG. 7 and FIG. 8 indicates the height of oil that is stored at the bottom in the transaxle case 20 during a stop of the vehicle. The rotor 11a and stator coil unit 11b of the electric motor 11 are also arranged at the level at which at least substantially the lower half of each of the rotor 11a and stator coil unit 11b of the electric motor 11 is immersed in oil that is stored at the bottom in the transaxle case 20 during a stop of the vehicle.

The case where the vehicle travels in the front-wheel-drive two-wheel-drive mode will be described. In the two-wheel-drive mode, the electric motor 11 is not in operation, so the rotor 11a and the stator coil unit 11b do not generate heat. In the two-wheel-drive mode, the first reduction gear pair 14, the second reduction gear pair 16 and the electric motor 11 co-rotate through the rear axles 18. When the vehicle travels at not a high vehicle speed but a low vehicle speed, such as about 5 km/h to 30 km/h, oil that is stored at the bottom in the transaxle case 20 is scooped up by the counter driven gear 23, the height of the oil begins to gradually decrease from the level H1 during a stop of the vehicle. In a low vehicle speed state, the height of oil that is stored at the bottom in the transaxle case 20 is the level H3. When the height of the oil is the level H3, the counter driven gear 23 and the rotor 11a are kept immersed in oil. The scoop-up amount of oil that is stored at the bottom in the transaxle case 20 increases with an increase in the vehicle speed from a low vehicle speed to a high vehicle speed, and the height of the oil begins to gradually decrease from the level H3 at the time when the vehicle travels at a low vehicle speed. When the vehicle travels at a high vehicle speed that is a vehicle speed of substantially 50 kilometers per hour, the height of oil that is stored at the bottom in the transaxle case 20 is the level H2 indicated by the alternate long and two-short dashes line in FIG. 2, FIG. 4, FIG. 7 and FIG. 8, and even the lowermost portion of the counter driven gear 23 of the first reduction gear pair 14 is almost not immersed in oil. On the other hand, the lower end of the final driven gear 26 of the second reduction gear pair 16 is kept immersed in oil.

Therefore, even when the vehicle travels at a high vehicle speed and it becomes difficult for the counter driven gear 23, which is higher in ability to scoop up oil than the final driven gear 26, to scoop up oil from the bottom in the transaxle case 20, the state where oil is allowed to be scooped up by the final driven gear 26 is maintained. Structurally, rotation of the final driven gear 26 is slower than that of the counter driven gear 23; however, when the vehicle travels at a high speed, rotation of the final driven gear 26 is also increased, so it is possible to scoop up oil from the bottom in the transaxle case 20 with the use of only the final driven gear 26. As described above, the predetermined angle θ is set such that the lowermost end Dy of the outer peripheral circle D of the rotor 11a is not immersed in oil stored in the case 20 while the vehicle is traveling on a hill having a gradient that falls within the predetermined angular range, in which the vehicle does not require auxiliary driving force that is generated by the electric motor 11. Thus, while the vehicle is traveling at a high vehicle speed as a result of acceleration of the vehicle from a low vehicle speed to a high vehicle speed, the height of oil decreases from the level H3 toward the level H2 as shown in FIG. 7, and the rotor 11a is not immersed in oil. Thus, it is possible to reduce the stirring resistance of the counter driven gear 23 and final driven gear 26 due to immersion of the rotor 1 la in oil during traveling of the vehicle.

Next, the case where the vehicle travels in the four-wheel-drive mode in which the rear axles 18 are driven by torque transmitted from the electric motor 11 by operating the electric motor 11 will be described. The four-wheel-drive mode is used when large driving torque is required, for example, when the vehicle starts moving, when the vehicle travels at a low vehicle speed or when the vehicle travels on an uphill, and it is required to cool the rotor 11a and stator coil unit 11b of the electric motor 11, which are the heat-generating portions, by the use of the splashes of oil. When the vehicle travels at a high vehicle speed, the driving force of the rear wheels 31 is not required, so the four-wheel-drive mode is not set, and the electric motor 11 is not in operation.

When the vehicle starts moving and travels on a flat road, the vehicle travels in the four-wheel-drive mode by driving the electric motor 11 not at a high vehicle speed but at a low vehicle speed, for example, 0 km/h to 30 km/h. Therefore, oil that is stored at the bottom in the transaxle case 20 is scooped up by the counter driven gear 23, the height of oil that is stored at the bottom in the transaxle case 20 begins to gradually decrease from the level H1 during a stop of the vehicle as shown in FIG. 7, and the height of oil that is stored at the bottom in the transaxle case 20 is the level H3 when the vehicle travels at a low vehicle speed. When the height of the oil is the level H3, the counter driven gear 23 and the rotor 11a are kept immersed in oil. In this way, when the vehicle starts moving and travels on a flat road in the four-wheel-drive mode by operating the electric motor 11, the rotor 11a is kept immersed in oil that is stored at the bottom in the transaxle case 20 in the range of the level H1 to the level H3, so the rotor 11a rotates to splash oil stored at the bottom in the transaxle case 20. Thus, it is possible to cool the rotor 11a and the stator coil unit 11b that are the heat-generating portions of the electric motor 11. While the vehicle is traveling at a high vehicle speed where the electric motor 11 is not in operation, the height of oil decreases from the level H3 toward the level H2 as shown in FIG. 7. When the rotor 11a is not immersed in oil, it is possible to reduce the stirring resistance of the counter driven gear 23 and final driven gear 26 due to immersion of the rotor 11a in oil during traveling of the vehicle.

Next, the case where the vehicle starts moving and travels on an uphill having a gradient of 11° in the four-wheel-drive mode in which the electric motor 11 is operated will be described with reference to FIG. 8. On the uphill having a gradient of 11°, from the relationship of the predetermined angle θ (substantially 5°), the angle that the lower-side common tangent TL of the outer peripheral circle P of the counter driven gear 23 and the outer peripheral circle D of the rotor 11a makes with the horizontal line HL is 11°-θ (substantially 5°), and the lowermost end Py of the outer peripheral circle P of the counter driven gear 23 is located above the lowermost end Dy of the outer peripheral circle D of the rotor 11a. Because of the upward gradient of 11°, the height of oil that is stored at the bottom in the transaxle case 20 in a low vehicle speed state rises to the level H3h higher than the level H3 in a flat road. Thus, the ability to splash oil by the use of rotation of the rotor 11a on an uphill improves.

In this way, when the vehicle travels on an uphill in the four-wheel-drive mode by operating the electric motor 11, the rotor 11a is kept in a state where the rotor 11a is further deeply immersed in oil that is stored at the bottom in the transaxle case 20 as a result of a change of the oil level from H3 to H3h as compared to the case of a flat road as shown in FIG. 8. Therefore, the rotor 11a is able to rotate to splash a larger amount of oil stored at the bottom in the transaxle case 20 toward the rotor 11a and the stator coil unit 11b that are the heat-generating portions of the electric motor 11. As a result, when the vehicle starts moving and travels on an uphill in the four-wheel-drive mode by operating the electric motor 11, the rotor 11a and the stator coil unit 11b that increase in generated heat as a result of operation of the electric motor 11 in need of auxiliary driving force that is generated by the electric motor 11 are cooled by the use of the splashes of oil resulting from rotation of the rotor 11a. When the drive mode changes to the four-wheel-drive mode in which the electric motor 11 is operated, that is, for example, when the vehicle travels on an uphill having substantially a gradient of five degrees or above, the lowermost end Py of the outer peripheral circle P of the counter driven gear 23 is not located below the lowermost end Dy of the outer peripheral circle D of the rotor 11a. Therefore, the rotor 11a is able to cool the rotor 11a and the stator coil unit 11b by rotating to splash a larger amount of oil stored at the bottom in the transaxle case 20 toward the rotor 11 a and the stator coil unit 11b that are the heat-generating portions of the electric motor 11.

As described above, the lubricating structure for a speed reducer according to the present embodiment includes the electric motor 11 arranged inside the transaxle case 20 (which is an example of a case) for the rear transaxle 10 (which is an example of a drive system of a vehicle), the reduction gear that rotates interlocking with the output shaft 12 of the electric motor 11, the pair of rear axles 18 (which are an example of a pair of drive axles) that are driven to rotate by torque transmitted from the electric motor 11 via the reduction gear, and the catch tank 32 stores part of oil that is stored at the bottom in the transaxle case 20, scooped up by the reduction gear and supplied to the lubricated portions and the rotor 11a and the stator coil unit 11b that are the heat-generating portions of the electric motor 11. In the lubricating structure, the reduction gear is located on the front side of the vehicle with respect to the rotor 11a of the electric motor 11, and is arranged such that the lower-side common tangent TL of the outer peripheral circle P of the reduction gear and the outer peripheral circle D of the rotor 11a is inclined upward from the front side of the vehicle toward the rear side of the vehicle at the predetermined angle θ with respect to the horizontal line HL. Thus, because the reduction gear that scoops up oil stored at the bottom in the transaxle case 20 is located on the front side of the vehicle with respect to the rotor 11a of the electric motor 11 and is arranged such that the lower-side common tangent TL of the outer peripheral circle P of the reduction gear and the outer peripheral circle D of the rotor 11a is inclined upward from the front side of the vehicle toward the rear side of the vehicle at the predetermined angle θ with respect to the horizontal line HL, immersion of the rotor 11a in oil stored at the bottom in the transaxle case 20 is maintained because of the predetermined angle θ in a state where the rotor 11a of the electric motor 11 is rotating. In a state where the vehicle starts moving and travels on an uphill, the lowermost end Py of the outer peripheral circle P of the reduction gear is allowed to be located above the lowermost end Dy of the outer peripheral circle D of the rotor 11a because of the predetermined angle θ. As a result, even in a state where the reduction gear is not immersed in oil stored at the bottom in the transaxle case 20, the rotor 11a is kept immersed in oil stored at the bottom in the transaxle case 20. Thus, it is possible to cool the rotor 11a and the stator coil unit 11b that are the heat-generating portions of the electric motor 11 by the use of the splashes of oil resulting from rotation of the rotor 11a.

As described above, with the lubricating structure for a speed reducer according to the present embodiment, the electric motor 11 is an auxiliary power source that generates auxiliary driving force in response to a vehicle traveling state, and the predetermined angle θ is set such that the lowermost end Dy of the outer peripheral circle D of the rotor 11a is not immersed in oil stored in the transaxle case 20 while the vehicle is traveling on a hill having a gradient that falls within the predetermined angular range, in which the vehicle does not require auxiliary driving force that is generated by the electric motor 11. Thus, while the vehicle is traveling, it is possible not to immerse the rotor 11a in oil stored in the transaxle case 20 when the electric motor 11 is not in operation, so it is possible to reduce the stirring resistance of the reduction gear due to immersion of the rotor 11a in oil during traveling of the vehicle.

As described above, with the lubricating structure for a speed reducer according to the present embodiment, the predetermined angle θ that the lower-side common tangent TL of the outer peripheral circle P of the reduction gear and the outer peripheral circle D of the rotor 11a makes with the horizontal line HL is substantially five degrees. Thus, generally, because the front wheels (not shown) that are the drive wheels begin to slip when the vehicle travels on an uphill that is a low μ road, such as a snow road, in a front-wheel-drive two-wheel-drive mode, the vehicle starts traveling by changing the drive mode to the four-wheel-drive mode by driving the rear wheels 31 with the use of the electric motor 11. The predetermined angle θ is set to substantially five degrees as the angle of such an uphill in this case. In the four-wheel-drive mode in which the electric motor 11 is operated, it is possible to prevent the lowermost end Py of the outer peripheral circle P of the reduction gear from being located below the lowermost end Dy of the outer peripheral circle D of the rotor 11a. As a result, even in a state where the reduction gear is not immersed in oil stored at the bottom in the transaxle case 20, the rotor 11a is kept immersed in oil stored at the bottom in the transaxle case 20. Thus, it is possible to cool the rotor 11a and the stator coil unit 11b that are the heat-generating portions of the electric motor 11 by the use of the splashes of oil resulting from rotation of the rotor 11a. On the other hand, the predetermined angle θ is set to substantially five degrees such that the lowermost end Dy of the outer peripheral circle D of the rotor 11a is not immersed in oil stored in the transaxle case 20 while the vehicle is traveling on a hill having a gradient that falls within the predetermined angular range in which the vehicle does not require auxiliary driving force that is generated by the electric motor 11. Thus, while the vehicle is traveling, it is possible not to immerse the rotor 11a in oil stored in the transaxle case 20 when the electric motor 11 is not in operation, so it is possible to reduce the stirring resistance of the reduction gear due to immersion of the rotor 11a in oil during traveling of the vehicle.

As described above, with the lubricating structure for a speed reducer according to the present embodiment, the output shaft 12 of the electric motor 11 and the pair of rear axles 18 are arranged coaxially with each other. Thus, the output shaft 12 and the pair of rear axles 18 are arranged coaxially with each other for space-saving arrangement.

As described above, the lubricating structure for a speed reducer according to the present embodiment includes the first reduction gear pair 14 provided between the output shaft 12 and the counter shaft 13 parallel to the output shaft 12 and the second reduction gear pair 16 provided between the counter shaft 13 and the differential case 15 parallel to the counter shaft 13 and accommodating the differential mechanism 17 that drives the pair of rear axles 18 to rotate, the reduction gear is a larger diameter one of the first reduction gear pair 14 and is the counter driven gear 23 fixed to the counter shaft 13, and the final driven gear 26 of the second reduction gear pair 16 that is lower in rotation speed than the counter driven gear 23 is fixed to the differential case 15. Thus, the invention is applicable to a vehicle including the differential case 15.

When there are a plurality of embodiments, unless otherwise specified, it is clear that characterized portions of the respective embodiments are allowed to be combined with each other as needed.

What is clamed is:

1. A lubricating structure for a speed reducer, the lubricating structure comprising:
a case for a drive system of a vehicle;
an electric motor arranged inside the case;
a reduction gear configured to rotate interlocking with an output shaft of the electric motor;
a pair of drive axles configured to be driven to rotate by torque transmitted from the electric motor via the reduction gear; and
a catch tank configured to store part of oil, which is stored at a bottom in the case and supplied to a lubricated portion and a heat-generating portion of the electric motor, by scooping up the oil with the use of the reduction gear, wherein
the reduction gear is located on a front side of the vehicle with respect to a rotor of the electric motor, and is arranged such that a lower-side common tangent of an outer peripheral circle of the reduction gear and an outer peripheral circle of the rotor is inclined upward from the front side of the vehicle toward a rear side of the vehicle at a predetermined angle with respect to a horizontal line.

2. The lubricating structure according to claim 1, wherein
the electric motor is an auxiliary power source configured to generate auxiliary driving force in response to a traveling state of the vehicle; and
the predetermined angle is set such that a lowermost end of the outer peripheral circle of the rotor is not immersed in the oil stored in the case while the vehicle is traveling on a hill having a gradient that falls within a predetermined angular range, in which the vehicle does not require the auxiliary driving force that is generated by the electric motor.

3. The lubricating structure according to claim 1, wherein
the predetermined angle is substantially five degrees.

4. The lubricating structure according to claim 1, wherein
the output shaft of the electric motor and the pair of drive axles are arranged coaxially with each other.

5. The lubricating structure according to claim 1, further comprising:
a first reduction gear pair provided between the output shaft and a counter shaft parallel to the output shaft; and
a second reduction gear pair provided between the counter shaft and a differential case parallel to the counter shaft and accommodating a differential mechanism configured to drive the pair of drive axles to rotate, wherein
the reduction gear is a larger diameter one of the first reduction gear pair, and is a counter driven gear fixed to the counter shaft, and
a final driven gear of the second reduction gear pair, which is lower in rotation speed than the counter driven gear, is fixed to the differential case.
